(19) United States
(12) Patent Application Publication
(10) Pub. No.: US 2008/0103868 A1
(43) Pub. Date: May 1, 2008

(54) Methods for planning workforce resources

(76) Inventors: Cipriano A. Santos, Modesto, CA (US); Dirk M. Beyer, Walnut Creek, CA (US); Ernesto Brau, Tucson, AZ (US); Shailendra K. Jain, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,407

(22) Filed: Oct. 31, 2006

(51) Int. Cl. G06F 15/02

(52) U.S. Cl. 705/9

(57) ABSTRACT

Embodiments include methods, apparatus, and systems for planning workforce resources. One method includes defining workforce supply and uncertain workforce demand for plural different service projects using a set of skills that are preferred to complete the plural different service projects; and calculating costs to hire new employees having the set of skills versus costs to train existing employees to have the set of skills.

### BACKGROUND

Workforce planning is a systematic process for developing strategies for organizational planning designed to satisfy workforce requirements based on an analysis and projection of demographic data. For many organizations, workforce planning is an important tool to identify and estimate appropriate workload staffing levels, budget allocations, and timelines in order to economically and efficiently plan and complete projects.

In many conventional workforce planning systems, an average future workforce requirement is estimated according to a historical trend and planned accordingly. The forecast of the future workforce requirement is generated from historical data of previous workforce requirements. A workforce demand curve is then extended to a future time, and a cost analysis is generated based on estimated future requirements. These approaches treat the future workforce requirement as an estimated constant and do not account for uncertainties in required and updated market information over time.

In some workforce planning systems, organizations are required to plan and even begin projects before the projects are awarded to the organizations. This situation occurs because a large lead time (example, several months or more) is often required to hire hundreds or even thousands of employees, especially if such employees are highly skilled. For instance, if a company bids on an outsourcing contract to provide information technology (IT) services, the company can begin hiring employees even before the outsourcing contract is awarded. In these instances, organizations assign a threshold probability of winning such contracts to each project and then evaluate the workforce requirement from projects with a winning probability (i.e., above the threshold).

These prior workforce planning systems are simple to implement: if the likelihood of winning a project is above a threshold, then preparation for the project commences. These systems, however, do not guarantee any service level of planning. Such approaches lead to poor availability levels of workforce and poor cost performance in workforce planning. For instance, the resulting projected probability is often below the threshold, yet the company later discovers that it won the contract. A workforce shortage or delays in performance can result. Moreover, this approach does not consider cost trade-offs between different projects and other resources. Such problems often occur with IT consulting and integration services where there is a funnel of project opportunities, but there is uncertainty about the acquisition of each project.

### BRIEF DESCRIPTION OF THE DRAWINGS

FIG. 1 is an exemplary flow diagram for showing stochastic and optimization stages for workforce planning in accordance with an exemplary embodiment of the present invention.

FIG. 2 is an exemplary flow diagram of an approach for funnel management and workforce planning in accordance with an exemplary embodiment of the present invention.

FIG. 3 is a block diagram of an optimization component in accordance with one embodiment of the present invention.

FIG. 4 is a block diagram of an exemplary computer system in accordance with one embodiment of the present invention.

### DETAILED DESCRIPTION

Embodiments in accordance with the present invention are directed to apparatus, systems, and methods for planning resources. Exemplary embodiments provide workforce planning that maximizes utilization of the available workforce and, at the same time, minimizes costs of filling gaps or vacancies in the workforce. Planning for the workforce considers various uncertainties with supply and demand and also utilizes flexibility that people have in terms of learning new skills and having multiple skills. This flexibility assists in maximizing workforce utilization and minimizing the costs of filling the gaps between workforce requirements and workforce available.

Generally, workforce planning under uncertainty is intractable at detailed skill levels, but more manageable at intermediate levels. In one exemplary embodiment, planning is performed at intermediate levels that are represented by high level skills called planning skillsets (PSS). A planning skillset is a set of skills describing a typical job or task of projects in a practice. Workforce requirements and availability are expressed in terms of PSS. Thus, resource requirements for projects are expressed at the PSS level. At this level, demand for each PSS is aggregated into a demand probability distribution, and workforce at the PSS level is tracked. In one exemplary embodiment, employees work in multiple PSSs. In terms of the PSS demand probability distribution, a determination is made of the PSS demand that can be satisfied at a given service level. Once the PSS demand is calculated, exemplary embodiments optimize the workforce utilization and the costs associated with filling the discrepancies between workforce requirements for one or more projects and the workforce available for hire or training.

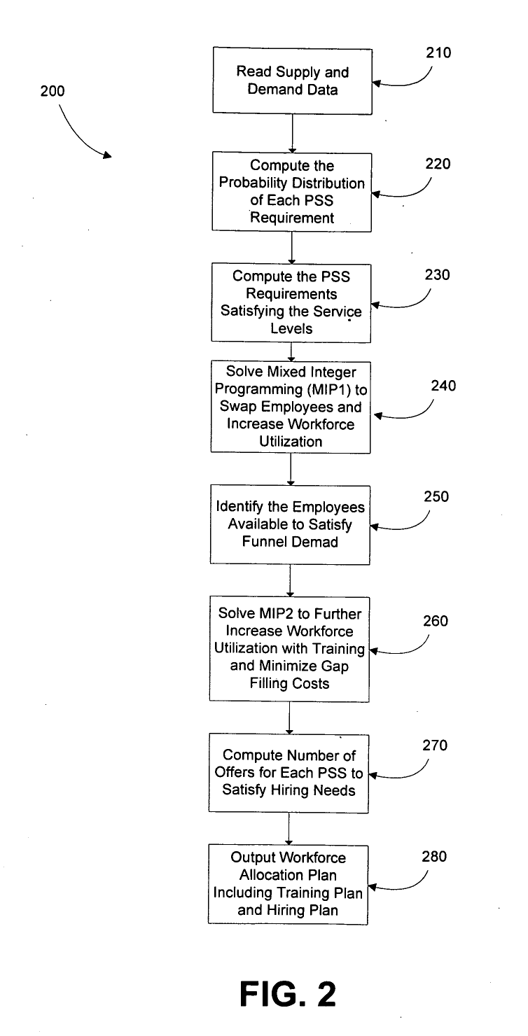

One exemplary method in accordance with the invention enables workforce planning under uncertainty by considering flexibility of workers to be further trained and by optimizing workforce utilization and associated costs of filling workforce gaps. For instance, demand uncertainty is addressed by computing the PSS demand in terms of the PSS demand probability distribution that satisfies a given service level. Workforce utilization is maximized and associated costs of filling the workforce gaps are minimized by formulating and solving a mathematical optimization problem (discussed in FIG. 2). This mathematical optimization problem is decomposed into two mixed integer programming (MIP) formulations.

The first MIP formulations increases workforce utilization by swapping or exchanging employees assigned to on-going projects with idle employees, and re-assigning them to projects in the funnel that idle employees cannot perform. For example, the first MIP formulation identifies employees with unique skills assigned to on-going projects requiring common skills that can be replaced by idle employees with common skills. A replaced employee is re-assigned to a project in the funnel requiring the unique skill. This MIP formulation minimizes disruption of employees assigned to on-going projects.

The second MIP formulation further improves workforce utilization by training and minimizing costs to fill gaps or vacancies in the workforce. For example, the second MIP formulation chooses the minimum cost between training employees and hiring employees to fill the workforce gaps of the funnel demand.

In one exemplary embodiment, needs in short and midterm workforce planning take into account uncertainty of (1) the workforce supply and demand and (2) the flexibility of the workforce. Flexibility of workforce is expressed by the ability of employees to have multiple skills and the ability of these employees to learn new skills. Uncertainty regarding supply and demand involves numerous factors. By way of example, uncertainty in demand for resources includes uncertainty about winning a project, starting a project on a certain date, duration of a project, resource requirements for a project, etc. Uncertainty in supply for resources includes uncertainty about attrition rates (i.e., reduction in numbers of employees due to resignation, retirement, death, et al.) and uncertainty about hiring employees.

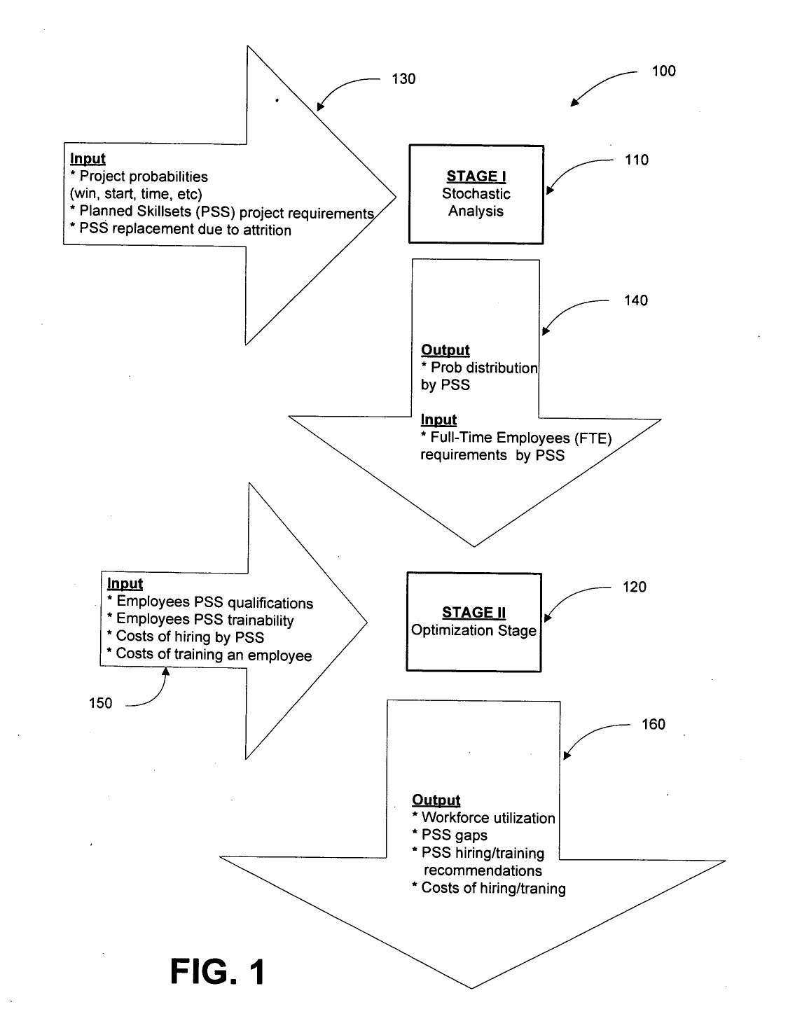

FIG. 1 is an exemplary flow diagram 100 for showing stochastic and optimization stages for workforce planning in accordance with an exemplary embodiment of the present invention. Workforce planning is divided into two stages: a stochastic analysis stage 110 and an optimization stage 120.

Input 130 is provided into the stochastic analysis stage 110. This input 130 includes various probabilities or forecasts for one or more projects or a funnel (i.e., the set of projects under promotion). By way of example, these probabilities include the probability of winning a project (i.e., securing a contract to perform business services) and the probability that a project will start on a given calendar date. For instance, starting time probabilities represent a conditional probability of starting a project at a period given that the project opportunity is won. The sum of these probabilities over the planning horizon should add to one.

Each project in the funnel also includes project requirements for PSS. PSS is a set of skills describing a typical job or task for a project. The set of skills varies according to the particular job or task. In one exemplary embodiment, PSS is divided into at least three categories, such as technology branch, stream, and job level. By way of example, technology branches include, but are not limited to, various high level programming languages (such as object oriented languages, C++, Java, etc.), enterprise application integration (data warehousing, application linking, etc.), inter-enterprise software applications, business-to-business transactions, and e-commerce transactions, to name a few examples. The stream category represents subparts or specialties of the technology branch. For instance, stream categories include, but are not limited to, development, support, consulting, and architecting, to name a few examples. The job level category represents job classifications or levels of expertise within each of the stream categories. The job levels include, but are not limited to, manager, supervisor, specialist, junior, expert, to name a few examples. The three categories (technology branch, stream, and job level) are used to define exemplary PSS definitions. Using the above examples, one combination of a PSS is Java Support Specialist (Java representing the technology branch, Support representing the stream, and Specialist representing the job level). Another example is a C++ Development Expert (C++ representing the technology branch, Development representing the stream, and Expert representing the job level). One skilled in the art appreciates that the number of categories, category descriptions, and category nomenclature are provided for illustrating the concept of PSS.

The input 130 also includes PSS replacement. In other words, once the different PSS project requirements are determined, additional workforce needs are calculated based on a rate of attrition. The rate of attrition can be relatively low (example, under 5%) or relatively high (example, 10%-15% or greater).

As shown in arrow 140, the stochastic analysis stage 110 provides an output that includes a probability distribution by PSS. In one exemplary embodiment, this output is a distribution of the full time employees (FTE) or the number of full time people needed for each PSS. This output is coupled with further input (shown as FTE requirements at each service level by PSS) and provided as input to the optimization stage 120.

As shown in arrow 150, various inputs are provided into the optimization stage 120. These inputs include employees PSS qualifications. In other words, the skills of each employee are determined, and these skills are matched with the set of skills in the PSS.

These inputs 150 also include employees PSS trainability. Once the skills of each employee are known, a determination is made as to amount of training required to move an employee to one or more different skill levels. By way of example, assume a PSS has a technology branch of Java programmers, and employee A within this branch has a stream category of consultant and a job level category of junior. Analyses are performed to determine the amount of training required to train employee A to have additional or different job levels within the stream category (example, job levels such as supervisor, expert, manager, etc.). Analyses are also performed to determine the amount of training required to train employee A to move or switch to additional or different stream categories (example, switch from the current stream category of consultant to developer, support personnel, architecting personnel, etc.).

These inputs 150 into the optimization stage 120 also include costs of hiring by PSS and costs of training an employee. Once the PSS is divided into the categories (such as technology branch, stream, and job level), the number of employees required for each job level is determined. This number could be quite large and include thousands or tens of thousands of employees. The cost of hiring an employee with each specific job level is determined. For example, how much does it cost to hire a .NET support expert or a Java consultant specialist? Further, the cost of training an employee to a specific job level is determined. For example, how much does it cost to train a .NET support expert or a Java consultant specialist?

The optimization stage 120 provides an output 160 that maximizes workforce utilization and at the same time minimizes costs of filling gaps or vacancies in the workforce. This output includes workforce utilization, PSS gaps, recommendations for PSS hiring, recommendation for PSS training, costs of hiring, and costs of training. For example, the optimization stage could determine that the cost of hiring 50 Java consultant specialists is $X; however, the cost of training 50 Java consultant specialists is $X minus $Y. Thus, it is more cost effective to train the Java consultant specialists as opposed to hiring them (assuming the employees are trainable before the projected start time). A mathematical optimization engine is not needed to make this calculation. The value of the optimization engine is to identify if there are 50 Java specialists available that can be trained on time to satisfy PSS requirements.

In one exemplary embodiment, the flow diagram 100 provides optimizations for short or mid-term workforce planning (example, planning for hiring and training employees within 4 to 12 months time period). For anticipating demand, workforce requirements for the funnel are expressed in terms of PSS. Here, exemplary embodiments compute the PSS probability distribution and determine different PSS requirements at different service levels (i.e., levels at which an expectation exists to satisfy demand). On the supply side, workforce availability is expressed in terms of PSS. For instance, an employee qualification table is generated to identify the PSS that each employee possesses. Exemplary embodiments identify the current workforce that is available to be allocated to satisfy funnel anticipated demand. Exemplary embodiments answer questions such as when and who can satisfy anticipated demand of a PSS. Employees are ranked by PSS, and exemplary embodiments allocate employees to a PSS to which the employee is most qualified. Further, an employee trainable table is generated to identify the PSS to which each employee can be trained. Estimations are calculated for hiring employees at the required skill levels and for training employees to the required skill levels. In other words, exemplary embodiments identify the current workforce that can be trained in order to increase workforce utilization while considering both training costs and lead times for training employees. Exemplary embodiments answer such questions as when and who to train for a required PSS or a required skill level for each project in the funnel. Further yet, an on-going projects assignment table is also generated. This table identifies PSSs of on-going or current projects to which each employee has been currently assigned. A determination is also made of employees that can be swapped, exchanged, or moved (example, present employees that are assigned to a project but not currently working in billable functions or roles).

Exemplary embodiments also identify anticipated demand of PSSs required to be hired in a project and consider hiring costs, lead times for hiring/training, and probabilities that employees will accept offers. Exemplary embodiments answer such questions as when and what type of PSSs are needed to hire. If appropriate costs of hiring and training are provided into the optimization stage, then exemplary embodiments provide plans for both hiring and training. The supply and demand information thus enables the optimization stage to minimize employee training and hiring costs to fill gaps yet optimize workforce utilization.

FIG. 2 is an exemplary flow diagram 200 of an approach for funnel management and workforce planning in accordance with an exemplary embodiment of the present invention.

According to block 210, the supply and demand data is read. The demand data includes both funnel demand and on-going projects demand. By way of example, the funnel demand includes project identification (i.e., a unique project identification number for projects in the funnel), the probability of winning the project opportunity, project PSS requirements (i.e., the number of employees with PSS required by the project), and PSS service level. The PSS service level is the service level at which an exemplary embodiment expects to satisfy demand. For example, if the service level (SL)=80%, then plan to have resources available to satisfy demand 80% of the time. The on-going projects demand includes the number of employees with PSS assigned to on-going projects. In one exemplary embodiment, this demand is deterministic and most always satisfied. This demand is not subject to a service level, since in this case demand is always satisfied at 100%. Moreover, since this demand most always is satisfied, one embodiment computes replacement requirements of employees assigned to on-going projects that leave the company due to attrition.

By way of example, the supply data includes employee PSS qualifications (example, a table that describes the PSSs that each employee has), employee training qualifications (example, a table that determines which PSSs an employee can be trained for), cost of training an employee for PSS, employees assigned to on-going project using PSS (example, a table that defines which PSS an employee is using for on-going projects), hiring costs of a person with PSS qualifications, and probability of accepting an offer.

According to block 220, a computation is made of the probability distribution of each PSS requirement. More specifically, the PSS demand probability distribution is computed as the convolution of the PSS requirements of projects in the funnel and the PSS replacement requirements of employees assigned to on-going projects that leave the company due to attrition.

The workforce requirement is the number of employees with planning skillset j required for project i, and it is a random variable denoted by X_{i,j}. Each planning skillset (PSS) is called job, since a PSS represents the set of skills required to perform a standard job of projects in a practice. The probability distribution of workforce requirements for job j of project i is:

$$Pr \{ {X}_{i , j} ) = \{ \begin{matrix}{p}_{i} & {X}_{i , j} = {x}_{i , j} \\ 1 - {p}_{i} & {X}_{i , j} = 0\end{matrix} .$$

In this equation, x_{i,j} is the number of employees required to perform job j of project opportunity i. It is assumed that the probability of winning a project is independent of winning other projects that require job j. Exemplary embodiments compute the total number of employees required to perform job j by all projects in the funnel, which is the summation of independent random variables. Consequently, the probability distribution of the total number of employees required to perform job j needed by all projects is computed as the convolution of the X_{i,j} random variables. That is, the demand of employees required to perform job j needed by all project opportunities is defined by the following formula:

$${X}_{j} = {\sum }_{i} {X}_{i , j} .$$

Here, projects in the funnel that have not been won or for which it is no known when the project will start and no staffing decisions have been made are called project opportunities. One exemplary embodiment calls projects to the on-going projects that are fully staffed.

The probability distribution of Xⱼ is computed as the convolution of X_{i,j}. The replacement requirements, Yⱼ is the number of employees assigned to perform job j at on-going projects that leave the company due to attrition. It is assumed that Yⱼ is a random variable that has a Binomial distribution; where, mⱼ, the total number of employees assigned to perform job j at on-going projects, represents the number of trials of the Binomial distribution; and α-attrition rate, is the probability that an assigned employee to perform job j of an on-going project will leave the company. Hence, the probability distribution of replacement requirements is defined as follows:

$$Pr ( {Y}_{j} = k ) = ( \begin{matrix}{m}_{j} \\ k\end{matrix} ) * {{a}^{k} ( 1 - a )}^{{m}_{j} - k} k = 0 , 1 , … , {m}_{j} .$$

Consequently, the total demand of employees to perform job j is defined as the total number of employees to perform job j required by all project opportunities plus the total number of employees to perform job j required as replacements of employees assigned to on-going projects that leave the company due to attrition. Hence, the following:

Dⱼ=Xⱼ+Yⱼ.

In this equation, the distribution of Dⱼ is computed as the convolution of Xⱼ and Yⱼ.

According to block 230, a computation is made of the PSS requirements satisfying the service levels. Here, a determination is made of the requirements of job j that satisfy the service level SL. These calculations determine the funnel demand that are desired to satisfy with current workforce, training workforce or hiring. For a given Service Level (SL), computation is made for the cumulative distribution of the workforce demand for job j; (i.e., compute the funnel demand value for job j, dⱼ^{F}, such that Pr(Dⱼ≦dⱼ^{F})≧SL).

According to block 240, exemplary embodiments solve for MP1 to swap employees and increase workforce utilization. MIP1 identifies employees that can perform rare jobs. These employees are assigned to perform common jobs required by on-going projects. Idle employees are capable of performing these common jobs, hence idle employees replace assigned employee and the assigned employee are re-assigned to perform a rare job required by a project in the funnel. This MIP1 minimizes disruption of employees assigned to on-going projects. The MIP1 mathematical formulation follows:

### Indices and Set

WεW: Set of employees.
jεJ: Set of jobs.

### Parameters

dⱼ^{F}: Funnel FTE requirements to perform job jεJ.
dⱼ^{P}: On-going projects FTE requirements to perform job jεJ.
Q_{w,j}=1: If employee w is qualified to perform job j.
A_{w,j}=1: If employee w has been assigned to perform job j of on-going projects.
M₁: Penalty of re-assigning an employee from an on-going project to a project opportunity.
M₂: Penalty for having a gap. It is assumed that M₁<M₂.

### Decision Variables

x_{w,j}=1: If and only if employee w is assigned to perform job j.
yⱼ≧0: Number of employees required to fill the gap of job j.
MIP1 Formulation
1) Satisfy demand of jobs required by on-going projects and projects in the funnel. For each jεJ, satisfy job demand of workforce:

$${\sum }_{w ∈ W}^{ } {Q}_{w , j} * {x}_{w , j} + {y}_{j} = {d}_{j}^{P} + {d}_{j}^{F} .$$

2) Satisfy capacity constraint that at most one employee is assigned to perform a job. For each WεW, satisfy:

$${\sum }_{j ∈ J}^{ } {Q}_{w , j} * {x}_{w , j} \leq 1.$$

3) Satisfy qualifications constraints. For each WεW and jεJ satisfy:

x_{w,j}ε{0,Q_{w,j}}.
4) Non-negativity constraint for gap variables. For each jεJ satisfy:

yⱼ≧0.
5) Objective function: Minimize penalties of re-assignment or having gaps:

$$Min {M}_{1} * {\sum }_{w ∈ W \\ j ∈ J}^{ } {A}_{w , j} * ( 1 - {x}_{w , j} ) + {M}_{2} * {\sum }_{j ∈ J ( F )}^{ } {y}_{j} .$$

In one exemplary embodiment, the planner controls the swapping of employees by defining the set of assigned employees to on-going projects that cannot be replaced by idle employees. That is,

$${x}_{w , j} {=}^{force} 1 w ∈ \overline{W} ,$$

where W̅ is the set of employees assigned to on-going projects that cannot be replaced.

According to block 250, an identification is made of employees who are available to satisfy the demand of the funnel. MIP1 defined an optimal swapping of employees assigned to on-going projects with idle employees to increase workforce utilization. At this step, exemplary embodiments fix the employees assigned to on-going project as determined by MIP1, and identify the employees available to satisfy funnel demand. First, an algorithm is defined to identify employees that are assigned to on-going projects.

In step 1, exemplary embodiments identify the set of employees that were assigned to on-going projects and were not moved (fixed) by the optimization model.

W^{f}={wεW:A_{w,j}*x*_{w,j}=1jεJ}.

In step 2, exemplary embodiments identify the set of employees that were assigned to on-going projects and were moved by the optimization model.

W^{m}={wεW:A_{w,j}*(1−x*_{w,j})=1jεJ}.

In step 3, for each job j, calculate the demand of on-going projects that the model recommends to satisfy with idle employees.

$${δ}_{j} = {d}_{j}^{P} - {\sum }_{w ∈ W ( f )}^{ } {A}_{w , j} .$$

In step 4, exemplary embodiments, identify the set of employees that will be assigned to jobs of on-going projects. Here, let the following occur:

W^{P}={wεW: employees assign to jobs of ongoing projects}.

In step 4(a), exemplary embodiments initialize the set of employees assigned to on-going projects W^{P}=W^{f}.

In step 4(b), exemplary embodiments identify the idle employees that the model recommends to satisfy the remaining demand from on-going projects. The set of eligible employees to satisfy the remaining demand δⱼ of ongoing projects is W^{e}=(W^{f}∪W^{m})^{C}. Then, execution of the following sub-routine occurs:

```
For j ∈ J Do
  count = δⱼ
  For (w ∈ W^{e} [symbol] count > 0) Do
    If ( x_{w,j}* = 1 ) Then
      Add employee w to set W^{P} :
        W^{P} ← W^{P} ∪ {w}
      Reduce remaining demand of on-going projects :
        count = count − 1
    End-If
  End-for
End-for
```

Here, the set W^{P} contains now all the employees assigned to on-going projects. This set will be fixed for the next MIP, where an exemplary embodiment determines an optimal way of filling the gaps. Also, it should be noted that at most one job is assigned to each employee; therefore, there is no risk to consider the same employee for two different jobs. Hence a need does not exist to track which employees are assigned to each job.

Finally, the employees that are available for assignment to jobs of project opportunities in the funnel is:

W^{a}=W−W^{P}.

According to block 260, exemplary embodiments solve MIP2 to further increase workforce utilization with training and to minimize gap filling costs. MIP2 considers the employees available, W^{a}, to satisfy funnel demand, dⱼ^{F}. The formulation of MIP2 follows:

### Parameters

j^{F}={jεJ:dⱼ^{F}>0}. This is the set of jobs that are required by projects in the funnel.
Q_{w,j}^{train}=1: If employee w can be trained to perform job j.
C_{w,j}^{train}: Cost of training employee w to acquire the skillset required by job j.
Cⱼ^{hire}: Cost of hiring an employee that has the skillset required by job j.

### Decision Variables

x_{w,j}^{train}=1: If and only if employee w is assigned to perform job j.
hⱼ≧0: Number of people we plan to hire to fill the gap of job j.

### MIP2 Formulation

1) Satisfy demand of jobs required by project opportunities in the funnel. For each jεJ^{F}, satisfy job demand of workforce:

$${\sum }_{w ∈ W ( a )}^{ } {Q}_{w , j} * {x}_{w , j} + {y}_{j} = {d}_{j}^{F} .$$

Note that workforce available is the total workforce capacity where a subtraction is performed of the employees assigned to on-going projects. This workforce available includes employees previously assigned to jobs of on-going projects and idle employees.
2) Satisfy capacity constraint that at most 1 employee can be assigned to perform a job. For each wεW^{a}, satisfy:

$${\sum }_{j ∈ J ( F )}^{ } {Q}_{w , j} * {x}_{w , j} \leq 1.$$

### Here, since jobs of on-going projects are satisfied, exemplary embodiments identify from the workforce available the employees that can perform jobs required by project opportunities in the funnel.

3) Filling the gap constraints. Gaps can be filled by training available employees or hiring new ones. For each jεJ^{F} satisfy:

$${y}_{j} = {\sum }_{w ∈ W ( a )}^{ } {Q}_{w , j}^{train} * {x}_{w , j}^{train} + {h}_{j} .$$

4) Satisfy qualifications constraints: For each wεW^{a} and jεj^{F} satisfy the following:

x_{w,j}ε{0,Q_{w,j}} and x_{w,j}^{train}ε{0,Q_{w,j}^{train}}.
5) Non-negativity constraint for gap and hire variables: For each jεj^{F} satisfy:

yⱼ,hⱼ≧0.
6) Objective function: Minimize costs of filling gaps through training or hiring:

$$Min {\sum }_{w ∈ W \\ j ∈ J}^{ } {C}_{w , j}^{train} * {Q}_{w , j}^{train} * {x}_{w , j}^{train} + {\sum }_{j ∈ J ( F )}^{ } {C}_{j}^{hire} * {h}_{j} .$$

According to block 270, a computation is made of the number of offers according to PSS to satisfy the hiring needs. In other words, exemplary embodiments compute the number of offers needed to hire the people required for job j in order to satisfy the hiring needs specified by MIP2. To this end, define θⱼ as the probability that a person that can perform job j accepts an offer. It is assumed that Hⱼ, the number of people that accepts an offer has binomial probability distribution. That is, if nⱼ offers are made, the probability that hⱼ people accepts the offer is:

$$Pr ( {H}_{j} = {h}_{j} ) = ( \begin{matrix}{n}_{j} \\ {h}_{j}\end{matrix} ) {{θ}_{j}^{{h}_{j}} ( 1 - {θ}_{j} )}^{{n}_{j} - {h}_{j}} .$$

If nⱼ offers are made, the expected number of offers that are accepted is E(Hⱼ)=nⱼ*θⱼ. Hence, in order to compute the number of offers to make and have hⱼ people that accepts the offer, the following occurs: nⱼ=hⱼ/θⱼ.

According to block 280, a workforce allocation plan is output. In one exemplary embodiment, the workforce allocation plans are expressed by the table implied by the optimal values of x_{w,j}=1. The workforce training plans are expressed by the table implied by the optimal values of x_{w,j}^{train}=1. The hiring plans are expressed by the table implied by the optimal values of hⱼ>0.

Exemplary embodiments in accordance with the invention can be utilized in a variety of businesses and models. By way of example, one exemplary embodiment determines optimal human and/or non-human resources to acquire for multiple projects. By way of example, one embodiment determines optimal workforce staffing levels (trained and/or hired) for multiple projects, such as a portfolio of different and unrelated projects that are under bid or promotion by a company. One exemplary embodiment analyzes potential workforce requirements from plural different projects under promotion and designs an optimal workforce planning strategy. This approach uses optimization techniques to advance workforce planning and reduces risks associated with shortages and surpluses in workforce assignment.

One exemplary embodiment concerns the potential workforce requirement generated during promotion or pre-sales activities (example, before a contract is awarded or a service agreement is finalized between two parties or entities). In the information technology (IT) service business, for example, a sales force of a first company negotiates with one or more potential customers for the delivery of services or a set of business solutions. A funnel (i.e., the set of projects under promotion) collects a total of “n” projects that are under promotion or being offered for sale. The sales force provide estimations for different probabilities associated with each of the projects, such as, but not limited to, the probability of winning a project, project time window, starting time, potential workforce requirement, etc. The sales information of potential workforce requirement of the funnel is aggregated in order to generate and evaluate an optimal cost and hiring strategy.

Embodiments in accordance with the present invention assist in estimating workforce employees or staff (example, full time, part time, and contingent employees) for workforce requirements that have uncertainties. Sales information is systematically aggregated to assist in quantifying risks due to random market requirements. One exemplary embodiment analyzes the cost impact of a hiring strategy versus a training strategy (or combination of both strategies) and generates a cost-efficient workforce model. In the service industry, for example, availability and utilization of the workforce (i.e., the labor pool for employment) are two key performance indicators in workforce planning. On one hand, business opportunities are lost if the planned workforce level is too low. On the other hand, it is costly to reserve a high employment level of a given skill set if the market requirement is lower than a previous estimation. A dynamic programming tool analyzes the evolution of the funnel requirement and specifies how to meet the requirement using internal and external resources to minimize the overall or total operational costs for the projects.

In one embodiment, staffing levels for the projects are determined before the party providing the services receives a contract to perform the services and/or before the party begins to perform the services. Data is received for multiple different projects and this data is input into the stochastic stage. Input data includes, but is not limited to, demand expressed by the project funnel data and supply expressed by available resources in the market.

Generally, a determination is made of the resources required for each project. By way of example, each project generally requires a different number and degree of skilled employees that form the workforce for the particular project. At the same time, two or more projects often require the same type of skilled employee. For instance, several projects can each require employees having an expertise in a particular computer programming language, web-based enterprise application, network protocols, e-services, communications, etc. By way of example, two or more different projects each require personnel experienced in the same high-level object oriented programming language.

In one exemplary embodiment, the skill sets for each project are separated or divided into plural hierarchical categories (example, in accordance with the PSS). The hierarchy, for example, is categorized according to one or more of skill, expertise, years experience, certifications, education, etc. For instance, project A could require 10 different skill sets; project B requires 8 different skill sets; project C requires 12 different skill sets, etc. These projects also include overlap or commonality between skilled employees required to complete the project. For example, projects A and C both require employees with skill set 1 (data management) or skill set 2 (computer programming), or skill set 3 (enterprise applications), etc.

Similar or common resources from each of the different projects are aggregated or grouped. In other words, common or similar resources for each project are added or grouped together. For instance, if project B requires 100 employees with skill set 1 and project C requires 75 employees with the same skill set 1, then the total number of employees for skill set 1 is 175 (assuming no other projects require skill set 1). This process of comparing and aggregating skill sets is repeated for each of the skill sets in each of the projects.

A determination is made for the optimal number or amount of resources to acquire (example, hire or train) for resource planning. By way of example, the optimal number of employees required for each skill set is not necessarily the aggregate total number for each skill set. Continuing with the example, assume that skill set 1 has a total number of required employees equal to 175. Thus, 175 employees having the same skill set are required if the company secures contracts or agreements for both projects B and C. During the pre-sale phase, however, neither project B nor C is finalized (i.e., the company has not yet entered into a contract or is not yet authorized to commence work according to the contract). The company may secure both projects, one of the projects, or none of the projects. The lead time for finding and hiring employees with skill set 1 is relatively long (example, several months), so the company is required to begin hiring employees before the projects are finalized.

The following example illustrates one exemplary embodiment in accordance with the present invention. In a typical outsourcing agreement, a customer enterprise (i.e., a business) enters into an agreement with a service provider to manage one or more business services or technical components of the customer enterprise. For example, a customer contracts with a service provider to manage one or more components or aspects of information technology (IT) services for the customer. The customer enterprise, however, solicits offers or bids from many different service providers to perform the IT services for each project. Thus, a plurality of different companies (companies A . . . N^{th}) bid or compete for plural different outsourcing projects (projects A . . . N^{th}). Each of these projects further requires different numbers and levels of skilled or trained employees. Each project is divided into common, similar, or identical skill sets (skill sets A . . . N^{th}).

In this example, each company has a funnel of projects or projects for which the company is bidding or attempting to contractually secure. The funnel thus consists of different and unrelated projects that a particular company has not yet secured. Company A, for instance, might bid on fifteen different projects (projects A through O) that are being offered by various different other companies. Further, each of these projects (A through O) has different service requirements and thus different workforce requirements. Project A has a workforce requirement that includes X different high level skill sets; project B has a workforce requirement that includes Y different high level skill sets, etc. Thus, each project requires different types of jobs with people having different expertise.

The time necessary to recruit and hire employees with relatively higher skills is long and can exceed several months. As such, company A cannot wait until a project is awarded and then start hiring for the awarded project. For instance, if company A has proposals or bids on fifteen different projects, company A must begin to hire and train employees even before the individual projects are awarded since the lead time for hiring and training skilled employee is relatively long.

Embodiments in accordance with the present invention are utilized in a variety of systems, methods, and apparatus. For instance, exemplary embodiments are applicable to both human and non-human resources. By way of example, such embodiments include, but are not limited to, estimating human resources (example, staffing or workforce levels for multiple projects) and estimating non-human resources. The non-human resources include a wide variety of resources required for one or more projects from relatively smaller items (such as office supplies and other tools and equipment associated with or needed to complete a project) to relatively larger items (such as computers, servers, office space, desks, chairs, IT equipment, capital equipment purchases, etc.). Such resources also include both tangible and intangible property, such as real estate requirements, office lease space, etc. Further yet, such resources include not only tangible or physical property but also services. For example, embodiments in accordance with the present invention include estimating or forecasting services required for the multiple projects, such as third party business service procurement, third party outsourced services, etc.

By way of example, assume a company desires to estimate human and non-human resources required for multiple different projects prior to receiving a contract to perform the services and/or before the company begins to perform the services. The initial input data includes demand expressed by the project funnel data and supply expressed by available resources in the market for both the human and non-human resources. Using this funnel data, a determination is made of the human resources required to hire and/or train for each project. Each project generally requires a different number and degree of such resources. For instance, each project requires different number or type of IT equipment, communication systems, office space, desks, computers, servers, network infrastructure, storage devices and networks, third party services, etc. At the same time, two or more projects often have overlap in such human and non-human resources. For instance, several projects can each require similar types of computing software, office lease space, storage networks, etc. Thus, projects include overlap or commonality with various human and non-human resources.

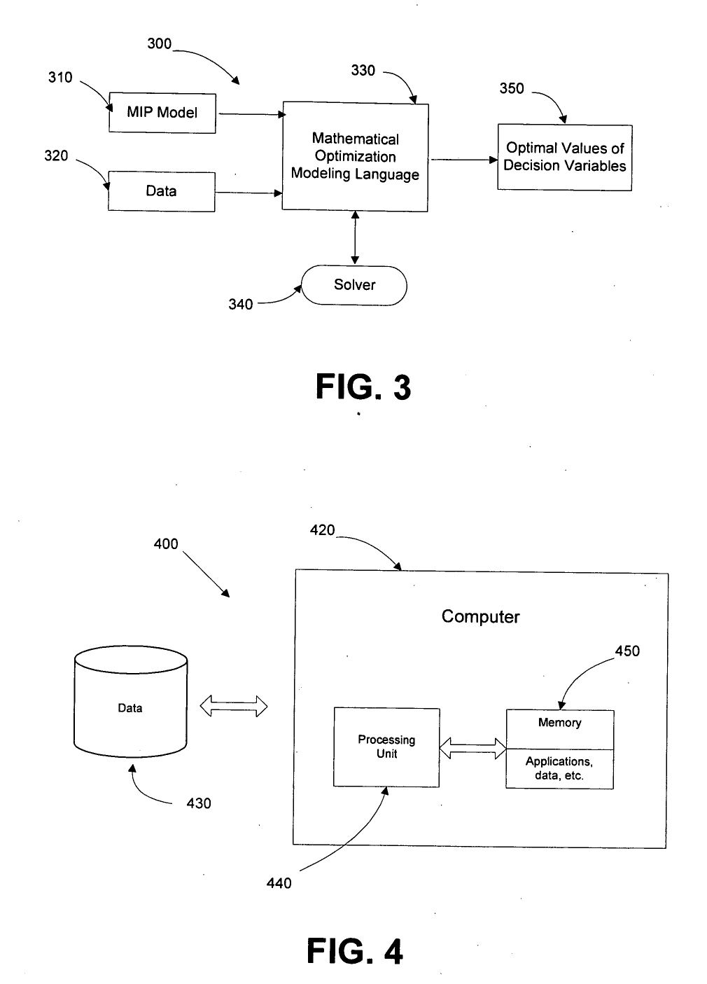

FIG. 3 is a high level block diagram of an optimization component 300 in accordance with one embodiment of the present invention. The optimization component 300 includes an MIP model 310 coupled to a mathematical optimization modeling language 330. Input data 320 and the MIP model couple to the mathematical optimization modeling language 330 which, in turn, couples and to a solver 340. Output from the mathematical optimization modeling language 330 is provided to optimal values of decision variables 350.

In one exemplary embodiment, the MIP model 310 is an algebraic representation of the optimization component. The data 320 is the input of the optimization component. The mathematical optimization modeling language 330 is a software tool that encodes the MIP model 310, reads the input data 320, calls the solver 340, and outputs the optimal values of the decision variables 350 of the MIP. The solver 340 is a library of algorithms to solve MIP problems. The optimal values of the decision variables 350 is the main output with the results from the solver 340.

FIG. 4 illustrates an exemplary embodiment as a computer system 400 for utilizing one or more of the flow diagrams and/or aspects of exemplary embodiments in accordance with the present invention.

The system 400 includes a host computer system 420 and a repository, warehouse, or database 430. The host computer system 420 comprises a processing unit 440 (such as one or more processors of central processing units, CPUs) for controlling the overall operation of memory 450 (such as random access memory (RAM) for temporary data storage and read only memory (ROM) for permanent data storage) and algorithms (which may be located in memory 450 or other location). The memory 450, for example, stores data, control programs, and other data associate with the host computer system 420. The processing unit 440 communicates with memory 450, data base 430, algorithms, and many other components via buses. These algorithms include, but are not limited to, the flow diagrams of FIGS. 1 and 2 and variations thereof.

Embodiments in accordance with the present invention are not limited to any particular type or number of databases and/or host computer systems. The host computer system, for example, includes various portable and non-portable computers and/or electronic devices. Exemplary host computer systems include, but are not limited to, computers (portable and non-portable), servers, main frame computers, distributed computing devices, laptops, and other electronic devices and systems whether such devices and systems are portable or non-portable.

As used herein, the term “business services” or “services” means human acts or processes that are typically performed for compensation. Further, as used herein, the term “outsourcing” includes contracting with a service provider to provide business services (example, managing certain non-core business operations). Further yet, as used herein the term “mathematical optimization” is a branch of applied mathematics to solve complex business and engineering problems. Some mathematical optimization models are called MIP (Mixed Integer Linear Programming) models. MIP can be coded by mathematical optimization modeling languages. These mathematical optimization modeling languages call a “solvers” to identify the optimal value of the decision variables of the MIP. Further, as used herein, “uncertainty” is a lack of information, knowledge, or data about an event (example, someone or something). Uncertainty can be expressed in terms of probability (example, chance that a given event will or will not occur).

In one exemplary embodiment, one or more blocks in the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision. Further, one or more of the skills and services discussed herein can be provided by a variety of resources, such as humans, computers, and combinations thereof.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method of software execution, comprising:
defining workforce supply and uncertain workforce demand for a service project using a set of skills that are required to complete the service project;
allocating available workforce to satisfy requirements by determining associated gaps in supply and demand and filling the gaps by training available workforce or hiring; and
assessing costs between (1) hiring a first person with at least a portion of the set of skills and (2) training a second person to have the portion of the set of skills.

2) The method of claim 1 further comprising:
identifying a current employee with unique skills assigned to an on-going service project;
calculating costs to replace the current employee with an idle employee from another on-going service project if the current employee is not required to use the unique skills in the on-going service project.

3) The method of claim 1 further comprising, minimizing costs by hiring the first person versus training the second person if hiring the first person costs less than training the second person.

4) The method of claim 1 further comprising:
defining the set of skills required to complete the service project with plural different categories that each require different fields of expertise;
determining which current employees have skill sets with at least two of the plural different categories.

5) The method of claim 1 further comprising, calculating probability in the workforce demand using probability about winning a bid for the service project and probability about starting the service project on a specified calendar date.

6) The method of claim 1 further comprising, calculating probability in the workforce supply using probability about attrition rates and probability about hiring employees with the set of skills.

7) A computer readable medium having instructions for causing a computer to execute a method, comprising:
dividing skills preferred to complete a business project into multiple skill levels;
evaluating supply and demand of available workforce with the multiple skill levels by addressing a demand of uncertainty, allocating available workforce to satisfy workforce needs, determining gaps between the supply and demand, and filling the gaps by training available workforce or hiring; and
calculating costs to train people and costs to hire people to satisfy a discrepancy between the supply of available workforce and the demand for the business project.

8) The computer readable medium of claim 7 further comprising, calculating a probability distribution of employees leaving due to attrition in order to estimate a number of full time employees to hire to complete the business project.

9) The computer readable medium of claim 7 further comprising:
evaluating skill levels of current employees working on other business projects;
calculating amounts of training to switch the current employees from one skill level to another skill level defined in the multiple skill levels.

10) The computer readable medium of claim 7 further comprising:
determining a number of employees requested for each of the multiple skill levels;
comparing a cost of hiring the number of employees with a cost of training the number of employees.

11) The computer readable medium of claim 7 further comprising, using hiring lead times of employees, estimated attrition for employees, and estimated project duration to calculate a number of employees to hire for project opportunities.

12) The computer readable medium of claim 7 further comprising:
calculating a gap between the supply of skill available from the workforce and the demand of skills needed by project opportunities in a funnel;
minimizing costs to fulfill this gap by analyzing costs to hire employees with skills for this gap versus training employees to have skills for this gap.

13) The computer readable medium of claim 7 further comprising:
generating a first table identifying skill levels of employees working on on-going projects;
generating a second table identifying skill levels to which the employees can be trained.

14) The computer readable medium of claim 7 further comprising:
identifying other business projects that have employees with the skills to complete project opportunities;
calculating costs of switching the employees from working on the other business projects to working on the business project.

15) The computer readable medium of claim 7 further comprising:
calculating the demand for the multiple skill levels in a funnel of other project opportunities;
calculating a total number of employees having the multiple skill levels.

16) A method, comprising:
defining workforce supply and uncertain workforce demand for plural different service projects using a set of skills that are preferred to complete the plural different service projects; and
calculating costs to hire new employees having the set of skills versus costs to train existing employees to have the set of skills.

17) The method of claim 16 further comprising, computing a total number of employees for each of the set of skills needed to complete each of the plural different service projects considering demand uncertainty.

18) The method of claim 16, further comprising:
identifying existing employees in the workforce supply that have skills to perform jobs in more than one of the plural different service projects;
calculating costs in switching the existing employees from a first service project to a second service project if the existing employees have skills to satisfy both the first and second service projects.

19) The method of claim 16 further comprising, calculating probability in the workforce demand using probability about winning a bid for each of the plural different service projects and probability about starting each of the plural different service projects on a specified calendar date.

20) The method of claim 16 further comprising, calculating probability in the workforce supply using probability about attrition rates and probability about hiring employees with the set of skills that are preferred to complete the plural different service projects.
